(19) United States
(12) Patent Application Publication
(10) Pub. No.: US 2015/0147217 A1
(43) Pub. Date: May 28, 2015

(54) NANOCOMPOSITE PERMANENT MAGNETS AND METHOD OF MAKING

(71) Applicant: General Electric Company, Schenectady, NY (US)

(72) Inventors: Francis Johnson, Clifton Park, NY (US); Wanming Zhang, Clifton Park, NY (US); Min Zou, Niskayuna, NY (US); Christina Hongbing Chen, San Jose, CA (US)

(73) Assignee: General Electric Company, Schenectady, NY (US)

(21) Appl. No.: 14/091,380

(22) Filed: Nov. 27, 2013

(51) Int. Cl. H01F 1/055; H01F 1/059; H01F 41/02; H01F 1/057

(52) U.S. Cl. CPC H01F 1/0556; H01F 1/0557; H01F 1/0576; H01F 1/0577; H01F 1/059; H01F 41/0266
USPC 419/23; 419/62; 164/47; 75/348; 75/228; 75/245

(57) ABSTRACT

An article having a nanocomposite magnetic component and method of forming a nanocomposite magnetic component are disclosed. The article includes a plurality of nanocrystalline flake particles bonded along their prior particle boundaries. The nanocrystalline flake particles have a median grain size less than about 30 nanometers and include a first set of grains comprising predominantly permanent magnet phase and a second set of grains comprising predominantly soft magnet phase.

### STATEMENT REGARDING FEDERALLY SPONSORED RESEARCH AND DEVELOPMENT

This invention was made with Government support under contract number DE-AR0000158 awarded by the U.S. Department of Energy. The Government has certain rights in the invention.

### BACKGROUND

The invention relates generally to nanocomposite permanent magnets, and more specifically to structure and method of making nanocomposite permanent magnets with enhanced energy product and reduced rare earth content.

Permanent magnet materials continue to be one of the most technologically sought after materials, with applications ranging from motors and generators, to high frequency electronic equipment. Electric machines that use permanent magnets as a source of magnetic flux exhibit the highest power density and efficiency. Hence, there is great demand for improved permanent magnets. This demand is driven by the utilization of permanent magnets in “green” energy technology such as hybrid vehicles and wind turbine generators. Furthermore, nanocomposite magnets are being designed to require less rare earth content than conventional magnets. Rare earths have been identified as important materials and their supply may become limited.

Research is focused in producing permanent magnets with high remanence (Br) and high coercivity (Hc), and thereby high energy product (BH)max. For an equivalent volume of the magnetic gap and the same strength of the magnetic field in the gap, a larger (BH)max of a permanent magnet results in a smaller volume of the permanent magnet. The development of higher energy products is complicated by the necessity of both a high coercivity and a high magnetization. Obtaining a high coercivity usually requires dilution of the primary magnetic species (Fe or Co), which lowers the magnetization and thus the achievable maximum energy product.

To overcome this limitation, research is focused on taking advantage of intergranular exchange interactions, ultimately forming two-phase structures combining high coercivity permanent magnet phases with low coercivity, soft magnet phases. In order to maximize the exchange interactions, this approach requires the phases to be assembled at minute scales.

Reducing particle size of the materials used and the separation between neighboring particles down to nanoscale could lead to novel magnetic coupling phenomena resulting in better permanent magnets. Therefore, there is a need for producing intimately mixed nanoscale parts of permanent magnet phases and soft magnet phases using an industrially viable method and quantity.

### BRIEF DESCRIPTION

Embodiments of the invention are directed towards a nanocomposite permanent magnet and method of making the same.

In one aspect of the invention, an article is disclosed. The article includes a nanocomposite magnetic component having a plurality of nanocrystalline flake particles bonded along their prior particle boundaries. The nanocrystalline flake particles have a median grain size less than about 30 nanometers and include a first set of grains having predominantly permanent magnet phase and a second set of grains having predominantly soft magnet phase.

In one aspect of the invention, an article is disclosed. The article includes a nanocomposite magnetic component that has a plurality of nanocrystalline flake particles bonded along their prior particle boundaries, and having a first set of grains having predominantly permanent magnet phase and a second set of grains having predominantly soft magnet phase. The median particle size of the nanocrystalline flakes is in a range from about 0.3 microns to about 5 microns, and an aspect ratio of the nanocrystalline flakes is in a range from about 5:1 to about 15:1; with a median grain size of the permanent magnet phase and soft magnet phase less than about 10 nanometers.

One aspect of the invention includes a method of forming a nanocomposite magnetic component. The nanocomposite magnetic component includes a plurality of nanocrystalline flake particles bonded along their prior particle boundaries. The nanocrystalline flake particles have a median grain size less than about 30 nanometers and include a first set of grains having predominantly permanent magnet phase and a second set of grains having predominantly soft magnet phase.

### BRIEF DESCRIPTION OF THE DRAWINGS

The disclosure may be understood more readily by reference to the following drawing, detailed description of the various features of the disclosure and the examples included therein.

FIG. 1 is a schematic diagram of a nanocomposite magnetic component according to one embodiment of the invention.

### DETAILED DESCRIPTION

In the following description, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group.

In the following specification and the claims that follow, the singular forms “a,” “an,” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, “predominantly” or “substantially,” may not be limited to the precise value specified, and may include values that differ from the specified value. In at least some instances, the approximating language may correspond to the precision of an instrument for measuring the value.

In the present discussions it is to be understood that, unless explicitly stated otherwise, any range of numbers stated during a discussion of any region within, or physical characteristic of, for instance, a permanent magnet phase, is inclusive of the stated end points of the range.

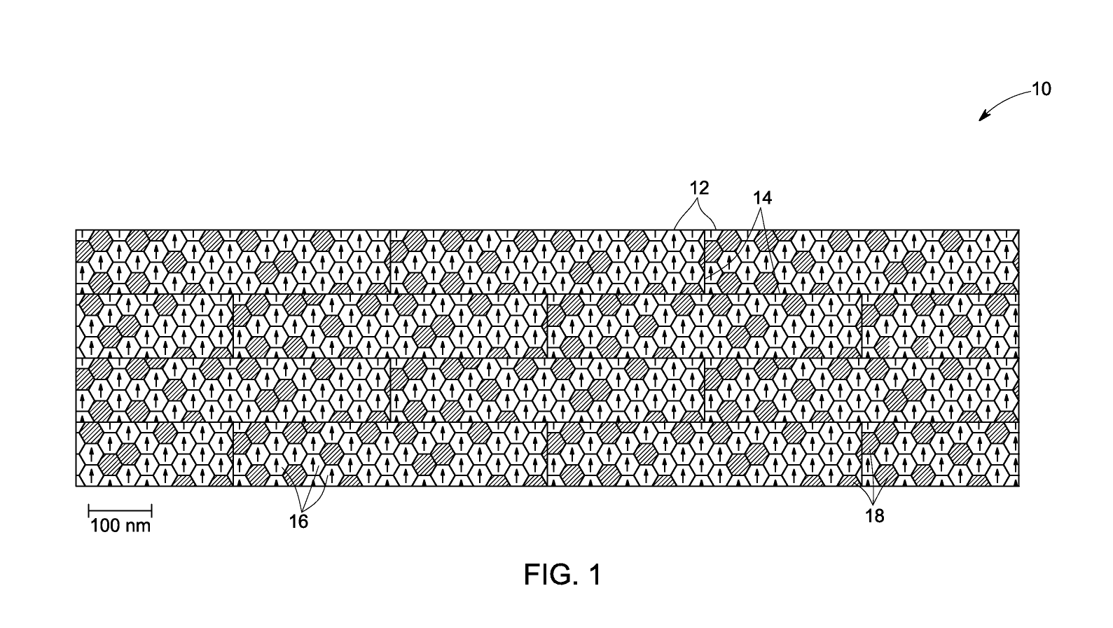

Embodiments of the invention disclosed herein include an article 10 including a nanocomposite magnetic component 10 depicted in FIG. 1 that has a plurality of nanocrystalline flakes 12 bonded along their prior particle boundaries 14 such that the nanocrystalline flakes 12 have two sets of grains. A first set 16 of grains include predominantly permanent magnet phase (alternately “hard magnet phase”) and a second set 18 of grains include predominantly soft magnet phase. The first 16 and second 18 set of grains both has a median grain size less than about 30 nanometers.

A “flake” as used herein is particle having one dimension (thickness) much less than the other two dimensions (length and width). A longest dimension of the flake is considered as the length and, alternatively, particle size of the flakes. A “nanoflake” is a flake having thickness less than about 100 nanometers. The term “nanocrystalline flake” as used herein indicates the high crystallinity (greater than 90 volume %) of the nanoflakes.

In general, the nanocrystalline flakes 12 of the present invention have an aspect ratio (width to thickness ratio) greater than about 2:1. In one embodiment, a median aspect ratio of the plurality of nanocrystalline flakes 12 is greater than about 3:1, and median length greater than about 0.3 micrometers. In one embodiment, a median length of the plurality of nanocrystalline flakes 12 is less than about 5 micrometers.

The plurality of nanocrystalline flake particles of various embodiments of the present invention includes at least two distinct phases. One of the phases is a permanent magnet phase and another a soft magnet phase. There may be other optional phases present in the flakes that may be magnetic or non-magnetic.

As used herein a permanent magnet phase as a part of the nanocrystalline flake particle is a magnetic material having a coercively greater than or equal to 1000 Oersteds. Further a soft magnet phase as a part of the nanocrystalline flake particle is a magnetic material having a coercively lower than 1000 Oersteds.

Various known permanent and soft magnetic materials may be used as the two distinct permanent and soft magnet phase of the nanocrystalline flakes 12. Non-limiting examples of the permanent magnet phase that may be used as a part of the nanocrystalline flakes 12 include a hard ferrite, well-known samarium cobalt compounds such as SmCo₅ and Sm₂Co₁₇, neodymium iron boron magnet (Nd₂Fe₁₄B), samarium iron nitride compound (Sm₂Fe₁₇N₃), either individually or in any combinations.

Non-limiting examples of the soft magnet phase that may be used as a part of the nanocrystalline flake include individual materials or any combinations of iron (Fe), Nickel (Ni), iron nickel alloys of various compositions (FeNi), iron cobalt alloys of various compositions (FeCo), soft ferrites, and some garnets.

The plurality of nanocrystalline flake particles of the article described in various embodiments of the present invention has both the permanent magnet phase and the soft magnet phase. In one embodiment, greater than about 90% of the total nanocrystalline flakes 12 have both the permanent magnet phase and the soft magnet phase materials as part of the grains of the individual flake particles. In other words, more than 90% of the nanocrystalline flake particles have the grains of both the first set 16 (permanent magnet phase) and the second set 18 (soft magnet phase). In one embodiment, more than 95% of the nanocrystalline flake particles have grains of both grain sets described above.

In one embodiment, the first set 16 of grains has more than 95 volume % of the permanent magnet phase. In one embodiment, the grains of the first set 16 include more than 99 volume % of grains of the permanent magnet phase. In a specific embodiment, the grains of the first set 16 include 100 volume % of grains of the permanent magnet phase. In one embodiment, the second set 18 of grains has more than 95 volume % of the soft magnet phase. In one embodiment, the grains of the second set 18 include more than 99 volume % of grains of the soft magnet phase. In a specific embodiment, the grains of the second set 18 include 100 volume % of grains of the soft magnet phase. The grains of the permanent and soft magnetic materials may have size less than about 40 nanometers. Diameter of a grain, which is defined as the longest distance of the single grain, is used to measure the size of the grains in the nanocrystalline flakes 12. An enhancement in performance of the nanocomposite permanent magnets is achieved through magnetic coupling of the permanent magnet phase and soft magnetic phase. This coupling is highly effective when the grain diameter within the nanocrystalline flakes 12 is less than about 30 nanometers.

If the grain diameters are too large, the magnetic coupling is less effective, thereby reducing the energy product to a value smaller than the constituent permanent magnet phase. In one embodiment, a median diameter of the plurality of grains, whether the grains are of the permanent magnetic material or of the soft magnetic material, is less than about 30 nanometers. In one embodiment, the median diameter of the plurality of grains is in a range from about 5 nanometers to about 30 nanometers. In a particular embodiment, a median grain size of the permanent magnet phase and the soft magnet phase is less than about 10 nanometers.

The enhancement in properties is realized as an increase in magnetic remanence and energy product. In one embodiment, the soft magnet phase has a remanence about twice that of the permanent magnet phase. It may be desirable to have the saturation magnetization of the soft magnetic phase greater than the permanent magnet phase to achieve an enhancement in energy product.

The grains of the permanent magnet phase and the grains of the soft magnet phase may be well-dispersed in the nanocrystalline flakes 12. In one embodiment, the grains of the nanocrystalline flakes 12 are arranged such that more than about 90% of the grains of the permanent magnetic material have more than about 50% of the nearest neighbors as the grains of the soft magnetic material. As used herein, a “nearest neighbor of a grain” is a neighboring grain that shares the same grain wall boundary as the originally mentioned grain.

The crystallographic orientation of the nanocrystalline flakes 12 may be isotropic or anisotropic. In one embodiment, the crystallographic orientation of the nanocrystalline flakes 12 is anisotropic, and the grains of the first set are substantially magnetically aligned. As used herein, the grains are substantially magnetically aligned, if the magnetic alignment (texture degree D_{T}) is greater than about 70%. If a remanence parallel to a magnetic alignment direction is denoted by B _{r(∥)}, and the remanence perpendicular to that magnetic alignment direction is denoted by B _{r(⊥)}, then a texture degree (D_{T}) is denoted by the equation:

D_{T}=[B_{r(∥)}]²/([B_{r(∥)}]²+[B_{r(⊥)}]²)

In one embodiment, the grains of the first set of the nanocrystalline flakes are having a texture degree D_{T} greater than about 90%.

The volume fraction of the soft magnet phase may be in a range from 1% to about 95% in the nanocomposite magnetic component 10. In one embodiment, a volume fraction of the grains of the permanent magnet phase is greater than the volume fraction of the grains of the soft magnet phase. In one embodiment, the volume fraction of soft magnet phase is in a range from about 10% to about 50%. An inclusion of soft magnet phase grains along with the permanent magnet phase grains may reduce coercivity of the nanocomposite magnetic component 10. An volume fraction of soft magnet phase in a range from about 10% to about 50% was experimentally found to yield enhanced energy product with an acceptable reduction in coercivity, as compared to a magnetic component having 100% permanent magnet phase.

Nanocomposite permanent magnets prepared by the embodiments of the present invention have energy products that exceed those of conventional permanent magnets made with similar compositions. This effect enhances the utility of the article for high temperature applications such as aircraft power systems. Furthermore, the nanocomposite permanent magnets may achieve improved performance while requiring smaller amounts of rare earth content.

Further embodiments of the invention disclosed herein include a method for manufacturing nanocomposite permanent magnets with the above-mentioned characteristics and having enhanced energy product and reduced rare earth content.

In one embodiment, the nanocomposites are manufactured from starting powders of nanocrystalline flakes 12 having grains of both permanent magnet phase and soft magnet phase. The nanocrystalline flakes 12 are produced by first casting ingots starting from a plurality of magnetic phase precursor elements to form both the permanent magnet phase and soft magnet phase during processing.

The precursor elements may include the elements that are going to be eventually present in the nanocrystalline flakes 12 including the final permanent magnet phase and soft magnet phase. In one embodiment, the nanocrystalline flakes 12 are designed to have SmCo₅ permanent magnet phase and an iron-cobalt soft magnetic alloy. In another embodiment, the nanocrystalline flakes 12 are designed to have Sm₂Co₁₇ permanent magnet phase and an iron-cobalt soft magnetic alloy. In both these cases, the precursor elements chosen to be in the ingots include iron, cobalt, and samarium. In one embodiment, the nanocrystalline flakes 12 are designed to have Nd₂Fe₁₄B phase with an iron soft magnetic alloy. In this case, the precursor elements chosen to be in the ingots include iron, neodymium, and boron.

The ratio of the individual precursor elements for the ingots is selected based on the final permanent and soft magnet phases needed to be present in the nanocomposite permanent magnet and the desired ratio of the soft magnet phase to the permanent magnet phase. In one example, about 76 to 95 atomic % cobalt, about 0 to 15 atomic % iron, and about 4.8 to 9.0 atomic % samarium were taken as the initial composition. These compositions were selected to produce nanocrystalline flakes 12 with SmCo₅ permanent magnet compound, and FeCo soft magnetic alloy. The specified composition ranges would produce a soft magnet phase volume fraction from 0 to about 52%.

The precursor elements used for making the ingots may react together and form alloys of permanent magnet phase and soft magnet phase at the time of formation of the ingots. In one embodiment, ingots are produced by arc melting. In another embodiment, the ingots are produced by induction melting.

The ingot with the permanent magnet phase and the soft magnet phase may be milled to form the nanoflakes. Initially, the ingot may be milled by general milling methods such as, for example, ball milling. The coarse powder may be further milled in an inert atmosphere to form the fine, nanocrystalline flakes 12 by high-energy milling In one embodiment, the milling may be assisted by a solvent, a surfactant, or a solvent and surfactant. The milled powder may be dried under inert conditions to form the nanocrystalline flakes 12 with a median thickness less than about 100 nm.

The nanocrystalline flakes 12 formed may be aligned by methods such as magnetic alignment and shear alignment. Depending on the magnetic alignment methods, and further consolidation methods, the mold used to pack the nanocrystalline flakes 12 may be rigid or flexible.

The powder in the mold may be consolidated by different methods such as by hot isostatic pressing, hot uniaxial pressing, die upsetting, spark plasma sintering, extreme shear deformation, equal channel angular extrusion, injection molding, or high pressure torsion, for example. Consolidation may be achieved by sintering, plastic deformation, or by bonding with a polymer or ceramic binder. The temperature of the consolidation may range from about 20° C. to about 900° C., depending on the method used for the consolidation.

In an example, nanocrystalline flakes having the coexisting grains of both permanent magnet phase and soft magnet phase were packed inside a flexible mold and aligned by exposure to a pulsed magnetic field of 10 Tesla. The aligned flakes were then pre-compacted at room temperature by cold isostatic pressing to form green bodies. The green bodies were consolidated by hot isostatic pressing at a temperature between about 660° C. and 680° C. with about 30 kpsi pressure, or uniaxial hot pressing at temperature in the range of about 500° C. to 700° C. with about 30-88 kpsi pressure. A density of 8.3 g/cm³ was achieved for the compacted nanocomposite magnetic component prepared by this method, and considerable increase in magnetization was noted.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An article, comprising:
a nanocomposite magnetic component comprising a plurality of nanocrystalline flake particles bonded along their prior particle boundaries, wherein the nanocrystalline flake particles have a median grain size less than about 30 nanometers, and wherein the particles comprise a first set of grains comprising predominantly permanent magnet phase and a second set of grains comprising predominantly soft magnet phase.

2. The article of claim 1, wherein a median grain size of the first set of grains and median grain size of the second set of grains are less than about 10 nanometers.

3. The article of claim 1, wherein the nanocrystalline flake particles have a median length in a range from about 0.3 microns to about 5 microns.

4. The article of claim 1, wherein the nanocrystalline flake particles have a median thickness less than about 100 nanometers.

5. The article of claim 1, wherein the nanocrystalline flake particles have an aspect ratio greater than about 3:1.

6. The article of claim 1, wherein the nanocrystalline flake particles have an aspect ratio in a range from about 5:1 to about 15:1.

7. The article of claim 1, wherein the permanent magnet phase comprises SmCo₅, Sm₂Co₁₇, Nd₂Fe₁₄B, Sm₂Fe₁₇N₃, a hard ferrite, or combinations thereof.

8. The article of claim 1, wherein the soft magnet phase comprises Fe, FeCo, FeNi, Ni, NiFe, soft ferrites, garnets, or combinations thereof.

9. The article of claim 1, wherein the component has a density greater than about 95% of theoretical density.

10. The article of claim 1, wherein an volume fraction of the grains of the permanent magnet phase is greater than the volume fraction of the grains of the soft magnet phase.

11. The article of claim 1, wherein the grains of the first set are substantially magnetically aligned.

12. An article, comprising:
a nanocomposite magnetic component comprising a plurality of nanocrystalline flake particles bonded along their prior particle boundaries, and comprising a first set of grains comprising predominantly permanent magnet phase and a second set of grains comprising predominantly soft magnet phase, wherein
a median particle size of the nanocrystalline flakes is in a range from about 0.3 microns to about 5 microns;
an aspect ratio of the nanocrystalline flakes is in a range from about 5:1 to about 15:1; and
a median grain size of the first set of grains and median grain size of the second set of grains are less than about 10 nanometers.

13. A method, comprising:
forming a nanocomposite magnetic component comprising a plurality of nanocrystalline flake particles bonded along their prior particle boundaries, wherein the nanocrystalline flake particles have a median grain size less than about 30 nanometers, and comprise a first set of grains comprising predominantly permanent magnet phase and a second set of grains comprising predominantly soft magnet phase.

14. The method of claim 13, wherein the forming step further comprises casting an ingot having the permanent magnet phase and soft magnet phase, starting from a plurality of magnetic phase precursor elements.

15. The method of claim 14, wherein the forming step further comprises milling the ingot, refining the grain size of the first set of grains and the second set of grains.

16. The method of claim 15, wherein the ingot is milled to form nanocrystalline flake particles with a median thickness less than about 100 nm

17. The method of claim 16, further comprising packing the nanoflake particles in a mold and aligning the nanocrystalline flake particles by exposing them to a magnetic field.

18. The method of claim 17, further comprising consolidating the powders by hot isostatic pressing, hot uniaxial pressing, spark plasma sintering, equal channel angular extrusion, or high pressure torsion, at a temperature in a range from about 20° C. to about 900° C.
